(19) United States
(12) Patent Application Publication
(10) Pub. No.: US 2017/0284273 A1
(43) Pub. Date: Oct. 5, 2017

(54) LIGHTWEIGHT POWER CELL UNIT

(71) Applicant: Mahle International GmbH, Stuttgart (DE)

(72) Inventors: Michael T. Lapp, Farmington Hills, MI (US); Scott Janowiak, South Lyon, MI (US); Alex Antoc, Sterling Heights, MI (US)

(73) Assignee: Mahle International GmbH

(21) Appl. No.: 15/089,192

(22) Filed: Apr. 1, 2016

(51) Int. Cl. F01P 3/10; F16C 7/02; F02F 3/22

(52) U.S. Cl. CPC F01P 3/10; F02F 3/22; F16C 7/023

(57) ABSTRACT

A power cell unit may include a piston assembly having a piston crown and a piston skirt. The piston crown may include a ring belt portion extending circumferentially about a combustion bowl and at least one boss portion extending downward from the combustion bowl. The power cell unit may also include a connecting rod having an elongated portion and a funnel portion, and at least one piston pin configured to connect the connecting rod with the piston assembly. A bottom surface of the at least one boss portion may engage with a corresponding surface of the funnel portion such that a gas load is substantially transferred directly from the piston crown to the connecting rod during downward motion of the piston assembly, and such that only inertial loading from the piston crown and/or piston skirt is transferred to the piston pin during upward motion of the piston assembly.

### BACKGROUND

A power cell unit of an internal combustion engine generally includes a reciprocating piston disposed within a cylinder of an engine block, and a connecting rod which joins a lower portion of the piston to a crankshaft. One end of the cylinder may be closed while another end of the cylinder may be open. The closed end of the cylinder and an upper portion or crown of the piston defines a combustion chamber. The open end of the cylinder permits oscillatory movement of the connecting rod, which is typically linked to the piston by a piston pin that is received within a piston pin bore defined by the piston.

Generally, fuel is combusted within the cylinders of the engine block to reciprocate the pistons. The piston drives the connecting rod, which drives the crankshaft, causing it to rotate within the engine block. Specifically, the combustion pressure within the cylinder drives the piston downward in a substantially linear motion but slightly rotational motion, which in turn drives the connecting rod in a similar motion via the piston pin at an end of the connecting rod. The combined linear and rotational movement of the connecting rod imposes a high level of stress on the ends of the connecting rod, particularly the end corresponding to the piston since it is configured to facilitate angular movement of the connecting rod relative to the piston pin and the piston during the reciprocal motion, particularly in the downward direction. This high level of stress is transferred to the connecting rod via the piston pin, and therefore the piston pin must be of substantial size to impart the necessary strength to bear such stress over a significant number of reciprocal cycles. It is accepted that the piston pin must be formed from a steel to perform adequately over the life of the power cell unit.

Nevertheless, it would be desirable to increase overall efficiency of an internal combustion engine while not sacrificing long-term performance. One approach is to reduce power cell unit weight, for example by reducing the weight of the piston pin. It has been thought, however, that by reducing weight either through size reduction or implementing different materials, such a piston pin would lack sufficient strength to survive over time.

Accordingly, there is a need for a more robust, lightweight power cell unit that offers reduced overall weight, for example through a reduced weight piston pin, while maintaining a stable and efficient connection between the connecting rod and the piston body that is maintained over the life of the internal combustion engine.

### BRIEF DESCRIPTION OF THE DRAWINGS

While the claims are not limited to the illustrated examples, an appreciation of various aspects is best gained through a discussion of various examples thereof. Referring now to the drawings, exemplary illustrations are shown in detail. Although the drawings represent representative examples, the drawings are not necessarily to scale and certain features may be exaggerated to better illustrate and explain an innovative aspect of an illustrative example. Further, the exemplary illustrations described herein are not intended to be exhaustive or otherwise limiting or restricting to the precise form and configuration shown in the drawings and disclosed in the following detailed description. Exemplary illustrations are described in detail by referring to the drawings as follows:

FIG. 1A is a perspective, cross-sectional view of a power cell unit according to one example;

FIG. 1B is a partial, cross-sectional view of the exemplary power cell unit of FIG. 1A;

FIG. 2 is a partial, cross-sectional view of a power cell unit according to another example;

FIG. 3 is a partial, cross-sectional view of a power cell unit according to yet another example;

FIG. 4 is a perspective view of an exemplary piston ring used in any of the exemplary power cell units of FIGS. 1A-3;

FIG. 5 is a partial, side view of a power cell assembly in a cylinder of an internal combustion engine;

FIG. 6 illustrates a process flow diagram of an exemplary process of operating any one of the exemplary power cell units of FIGS. 1A-3; and

FIG. 7 illustrates a process flow diagram of an exemplary process of operating the exemplary piston ring of FIG. 4.

### DETAILED DESCRIPTION

Reference in the specification to “an exemplary illustration”, an “example” or similar language means that a particular feature, structure, or characteristic described in connection with the exemplary approach is included in at least one illustration. The appearances of the phrase “in an illustration” or similar type language in various places in the specification are not necessarily all referring to the same illustration or example.

Various exemplary illustrations are provided herein of power cell units and methods of operating the same. An exemplary power cell unit may include a piston assembly having a piston crown and a piston skirt. The piston crown may include a ring belt portion extending circumferentially about a combustion bowl and at least one boss portion extending downward from the combustion bowl. The exemplary power cell unit may also include a connecting rod having an elongated portion and a funnel portion at one end of the elongated portion, and at least one piston pin configured to connect the connecting rod with the piston assembly. A bottom surface of the at least one boss portion may engage with a corresponding surface of the funnel portion such that a gas load is substantially transferred directly from the piston crown to the connecting rod during downward movement of the piston assembly, and such that only inertial loading from the piston crown and/or piston skirt is transferred to the piston pin during upward movement of the piston assembly.

An exemplary method of operating a power cell unit may include moving a piston assembly of a power cell unit, such as that described above, in a reciprocating manner. The method may then include transferring a gas load generated by the reciprocating movement of the piston assembly directly from the piston crown to the connecting rod of the power cell unit through a contact between a bottom surface of the at least one boss portion and a surface of a funnel of the connecting rod. The method may then include transferring an inertial load from at least one of the piston crown and the piston skirt to at least one piston pin. According to this exemplary method, the piston pin will only have to bear the inertial load, and not the gas load.

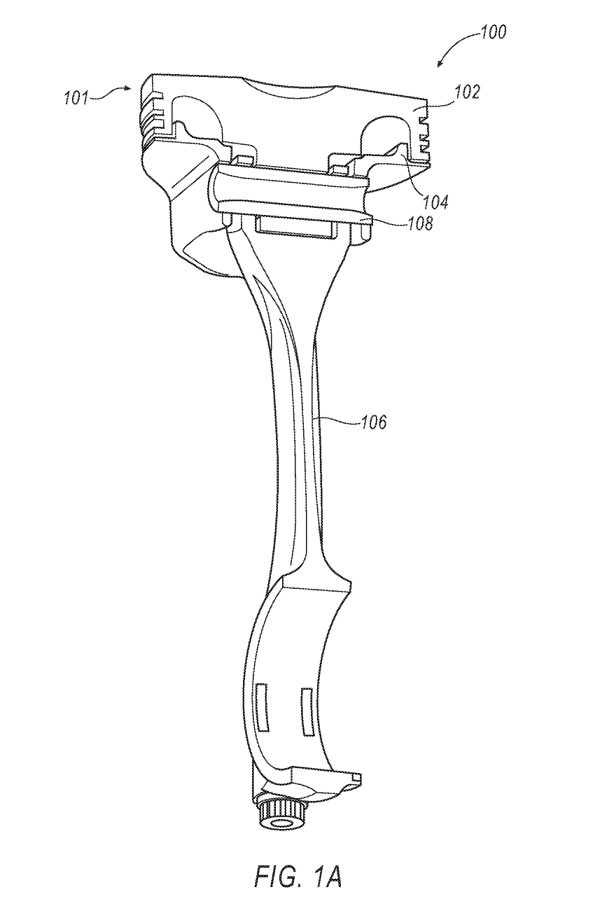

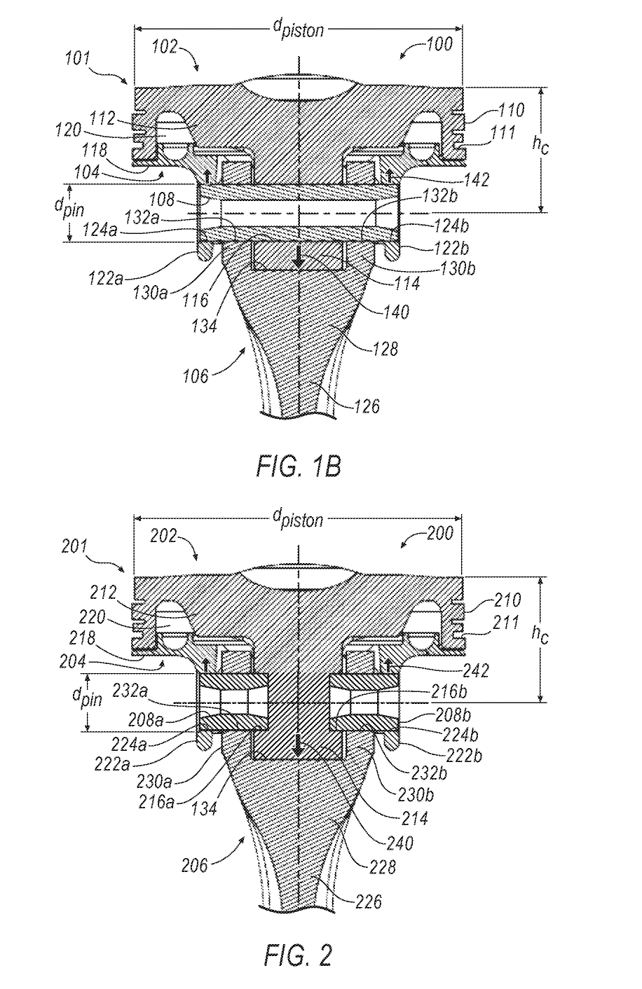

Referring now to the figures, FIGS. 1A and 1B illustrate an exemplary power cell unit 100. The power cell unit 100 may include a piston assembly 101, a connecting rod 106, and a piston pin 108. The piston pin 108 generally may secure the connecting rod 106 with the piston assembly 101 in such a manner that the connecting rod 106 may pivot with respect to the piston assembly 101, e.g., as may be necessary during operation of an engine employing the power cell unit 100. The piston assembly 101 may include a piston crown 102 and a piston skirt 104.

The piston crown 102 may include a ring belt portion 110 extending circumferentially around a combustion bowl 112. The ring belt portion 110 may define one or more circumferentially extending ring grooves 111. Each of the ring grooves 111 may be provided with a piston ring (not shown) to provide a seal with respect to associated bore surfaces of an engine employing the power cell unit 100. The piston crown 102 may also include a boss portion 114 extending axially downward from the combustion bowl 112. The boss portion 114 may extend along an axis of the piston assembly 101, and may define a bore 116 configured to receive the piston pin 108, as described in more detail hereinafter.

The piston skirt 104 may include a flange 118 that may cooperate with the piston crown 102 to form a cooling gallery 120 between the ring belt portion 110 and the combustion bowl 112. The cooling gallery 120 may receive coolant or lubricant via one or more apertures (not shown), which may receive a coolant or lubricant from a coolant jet (not shown) configured to circulate oil from an engine crankcase. The cooling gallery 120 may permit coolant or lubricant to exit back to the crankcase via one or more apertures (not shown). While the flange 118 is illustrated as being in contact with a lower edge of the ring belt portion 110 to generally close off the cooling gallery 120, in some exemplary illustrations, a gap between the radially outer end of the flange 118 and the lower edge of the ring belt portion 110 may be provided to allow ingress/egress of a coolant to/from the cooling gallery 120. The piston skirt 104 may further include walls 122a, 122b extending downward in an axial direction from the flange 118. The walls 122a, 122b may define bores 124a, 124b, respectively, configured to receive the piston pin 108.

The connecting rod 106 may include an elongated portion 126 and a funnel portion 128 at an end of the elongated portion 126 corresponding to the piston crown 102 and piston skirt 104. The funnel portion 128 may be fork-shaped with a pair of tines 130a, 130b defining a cavity 134 therebetween. The cavity 134 may be configured to receive the boss portion 114 of the piston crown 102 such that a bottom surface of the boss portion 114 is in contact with a bottom surface of the cavity 134. The tines 130a, 130b may also define bores 132a, 132b, respectively, configured to receive the piston pin 108 such that the connecting rod 106 may be rotatably secured to the piston crown 102 and the piston skirt 104. The bores 132a, 132b generally are aligned with the bores 116, 132a, and 132b along a common axis.

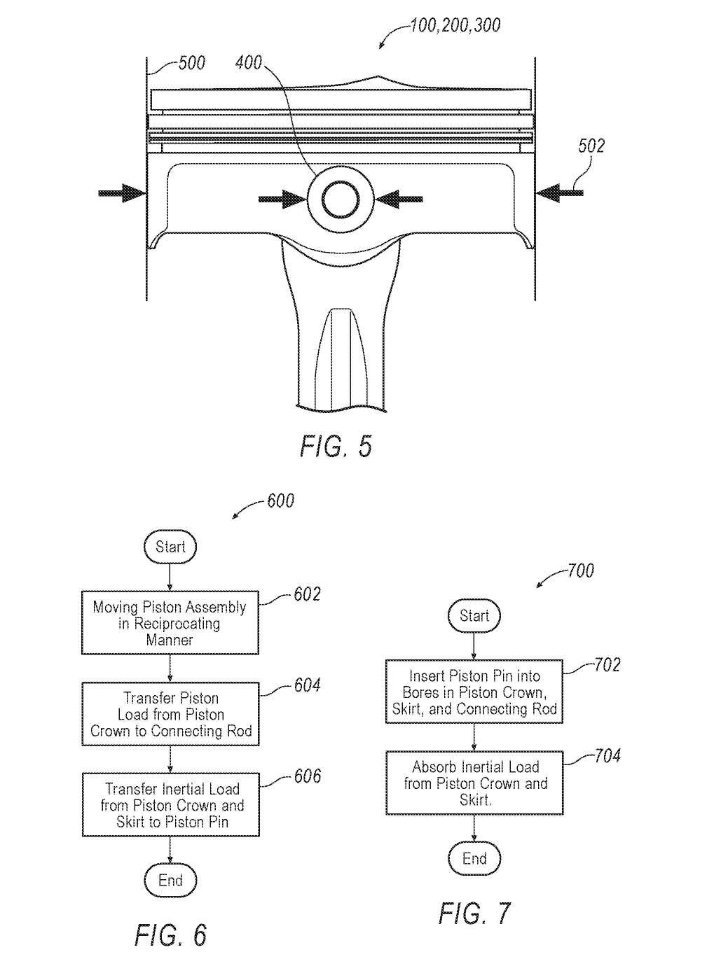

When the piston assembly 101 moves in a downward motion, for example, from a top dead center (TDC) to a bottom dead center (BDC), a large downward force or gas load (represented by arrow 140 in FIG. 1B), is generated. However, rather than the gas load 140 being transferred to the connecting rod 106 through the piston pin 108, as is the case in traditional power cell units, the gas load 140 may be substantially or completely transferred directly to the connecting rod 106 through the contact between the bottom surface of the boss portion 114 of the piston crown 102 and the bottom surface of the cavity 134 of the connecting rod 106. Further, the boss portion 114 may be aligned with an axis of the connecting rod 106, and therefore the gas load 140 may transfer directly to the elongated portion of the connecting rod 106. Thus, the primary function of the piston pin 108 is to secure the piston assembly 101 and the connecting rod 106, and therefore, the piston pin 108 only has to withstand much smaller inertial loading (represented by the smaller arrows 142) from the piston crown 102 and the piston skirt 104 during upward movement of the piston assembly 101, for example, from BDC to TDC. As merely an illustration of the difference between the gas load 140 and the inertial loading 142 that the piston pin 108 may have to bear, for a two-liter gas engine, the gas load may be greater than 75,000 N, whereas the inertial loading may be around 15,000 N. As such, as described in more detail hereinafter with respect to FIG. 5, the piston pin 108 may be substantially reduced in size from that of a traditional power cell unit, and/or may be made of a lighter material sufficient to withstand the inertial loading 142, thereby reducing weight of the piston pin 108 and overall weight of the power cell unit 100.

The piston assembly 101 may have a diameter, dₚᵢₛₜₒₙ, and the power cell unit 100 may also have a compression height, h_{c}, from the top of the piston assembly 101 to an axis of the piston pin 108. Due to its configuration, the power cell unit 100 may have a compression height ratio (i.e., compression height to piston diameter) smaller than traditional power cell units. For example, the compression height ratio may range from 20% to 37%, depending upon the specific application of the power cell unit. For a diesel engine, the compression height ratio may be 37% or lower. For gas engines, the compression height ratio may range from 20% to 35%, 20% to 28%, or 25% to 35% in different applications. For example, for a two-liter gasoline engine, the compression height ratio may be approximately 28.5%.

The piston pin 108 may also have a diameter, dₚᵢₙ. Due to the configuration of the power cell unit 100, a ratio of the pin diameter to the piston diameter may similarly be smaller than traditional power cell units. For example, the ratio may be less than 20%.

Referring now to FIG. 2, a power cell unit 200 according to another exemplary approach is illustrated. As with the power cell unit 100, the power cell unit 200 may include a piston assembly 201, a connecting rod 206, and a piston pin 208. The piston pin 208 generally may secure the connecting rod 206 with the piston assembly 201 in such a manner that the connecting rod 106 may pivot with respect to the piston assembly 201, e.g., as may be necessary during operation of an engine employing the power cell unit 200. The piston assembly 201 may include a piston crown 202 and a piston skirt 204.

The piston crown 202 may include a ring belt portion 210 extending circumferentially around a combustion bowl 212. The ring belt portion 210 may define one or more circumferentially extending ring grooves 211. Each of the ring grooves 211 may be provided with a piston ring (not shown) to provide a seal with respect to associated bore surfaces of an engine employing the power cell unit 200. The piston crown 202 may also include a boss portion 214 extending axially downward from the combustion bowl 212. The boss portion 214 may extend along an axis of the piston assembly 201. The boss portion 214 may define notches 216a, 216b in opposing sides of the boss portion 214 and configured to receive the piston pins 208a, 208b, respectively. The piston pins 208a, 208b may be press fit into the respective notches 216a, 216b.

The piston skirt 204 may include a flange 218 that may cooperate with the piston crown 202 to form a cooling gallery 220 between the ring belt portion 210 and the combustion bowl 212. The cooling gallery 220 may receive coolant or lubricant via one or more apertures (not shown), which may receive a coolant or lubricant from a coolant jet (not shown) configured to circulate oil from an engine crankcase. The cooling gallery 220 may permit coolant or lubricant to exit back to the crankcase via one or more apertures (not shown). While the flange 218 is illustrated as being in contact with a lower edge of the ring belt portion 210 to generally close off the cooling gallery 220, in some exemplary illustrations, a gap between the radially outer end of the flange 218 and the lower edge of the ring belt portion 210 may be provided to allow ingress/egress of a coolant to/from the cooling gallery 220. The piston skirt 204 may further include walls 222a, 222b extending axially downward from the flange 218. The walls 222a, 222b may define bores 224a, 224b, respectively, configured to receive piston pins 208a, 208b, respectively.

The connecting rod 206 may include an elongated portion 226 and a funnel portion 228 at an end of the elongated portion 226 corresponding to the piston crown 202 and piston skirt 204. The funnel portion 228 may be fork-shaped with a pair of tines 230a, 230b defining a cavity 234 therebetween. The cavity 234 may be configured to receive the boss portion 214 of the piston crown 202 such that a bottom surface of the boss portion 214 is in contact with a bottom surface of the cavity 234. The tines 230a, 230b may also define bores 232a, 232b, respectively, configured to receive the piston pins 208a, 208b, respectively such that the connecting rod 206 may be rotatably secured to the piston crown 202 and the piston skirt 204. The bores 232a, 232b generally are aligned with the bores 216, 232a, and 232b.

As with the power cell unit 100, when the piston assembly 201 of the power cell unit 200 moves in a reciprocating manner, for example, from a top dead center to a bottom dead center, a large downward force or gas load (represented by arrow 240), is generated. However, rather than the gas load 240 being transferred to the connecting rod 206 through a single piston pin, as is the case in traditional power cell units, the gas load 240 may be substantially transferred directly to the connecting rod 206 through the contact between the bottom surface of the boss portion 214 of the piston crown 202 and the bottom surface of the cavity 234 of the connecting rod 206. Further, the boss portion 214 may be aligned with an axis of the connecting rod 206, and therefore the gas load 240 may transfer directly to the elongated portion 226 of the connecting rod 206. Thus, two smaller piston pins 208a, 208b may be used, as the primary function of the piston pins 208a, 208b is to secure the piston assembly 201 and the connecting rod 206, and the piston pins 208a, 208b only have to withstand much smaller inertial loading (represented by the smaller arrows 242) from the piston crown 202 and the piston skirt 204. Therefore, the size and weight of each of the piston pins 208a, 208b may be substantially smaller than that of a traditional power cell unit, and/or may be made of a lighter material sufficient to withstand the inertial loading 242, thereby reducing the overall weight of the power cell unit 200.

The piston assembly 201 may have a diameter, dₚᵢₛₜₒₙ, and the power cell unit 200 may also have a compression height, h_{c}, from the top of the piston assembly 201 to an axis of the piston pin 208. Due to its configuration, the power cell unit 200 may have a compression height ratio (i.e., compression height to piston diameter) smaller than traditional power cell units. For example, the compression height ratio may range from 20% to 37%, depending upon the specific application of the power cell unit. For a diesel engine, the compression height ratio may be 37% or lower. For gas engines, the compression height ratio may range from 20% to 35%, 20% to 28%, or 25% to 35% in different applications. For example, for a two-liter gasoline engine, the compression height ratio may be approximately 28.5%.

The piston pin 208 may also have a diameter, dₚᵢₙ. Due to the configuration of the power cell unit 200, a ratio of the pin diameter to the piston diameter may similarly be smaller than traditional power cell units. For example, the ratio may be less than 20%.

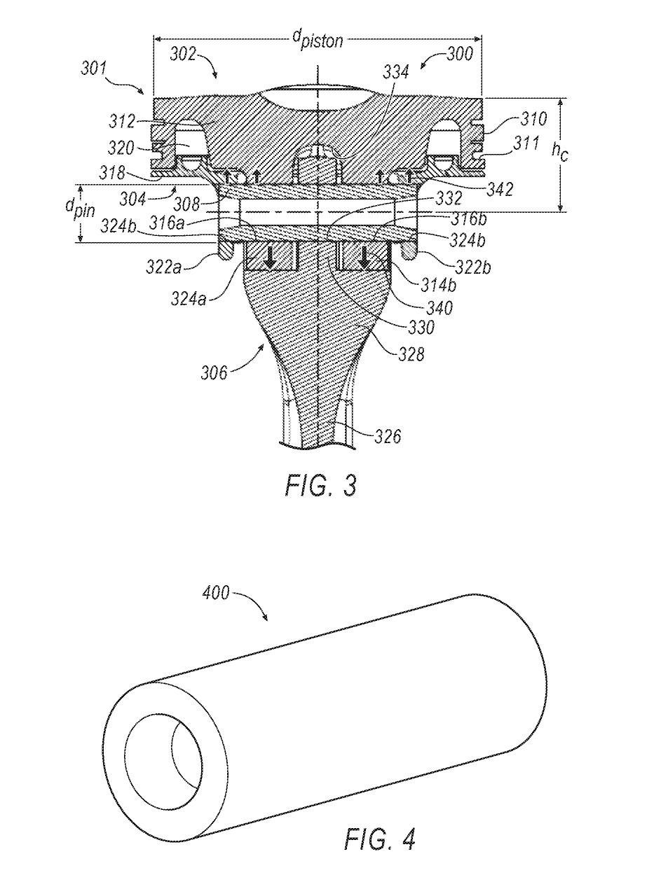

Referring now to FIG. 3, a power cell unit 300 according to another exemplary approach is illustrated. As with power cell units 100 and 200, the power cell unit 300 may include a piston assembly 301, a connecting rod 306, and a piston pin 308. The piston pin 308 generally may secure the connecting rod 306 with the piston assembly 301 in such a manner that the connecting rod 306 may pivot with respect to the piston assembly 301, e.g., as may be necessary during operation of an engine employing the power cell unit 300. The piston assembly 301 may include a piston crown 302 and a piston skirt 304.

The piston crown 302 may include a ring belt portion 310 extending circumferentially around a combustion bowl 312. The ring belt portion 310 may define one or more circumferentially extending ring grooves 311. Each of the ring grooves 311 may be provided with a piston ring (not shown) to provide a seal with respect to associated bore surfaces of an engine employing the power cell unit 300. The piston crown 302 may also include a pair of boss portions 314a, 314b extending downward in an axial direction from the combustion bowl 312. The boss portions 314a, 314b may be equally spaced radially from an axis of the piston assembly 301, and may define a cavity 334 therebetween. The boss portions 3141, 314b may further define a bore 316 configured to receive the piston pin 308, as described in more detail hereinafter.

The piston skirt 304 may include a flange 318 that may cooperate with the piston crown 302 to form a cooling gallery 320 between the ring belt portion 310 and the combustion bowl 312. The cooling gallery 320 may receive coolant or lubricant via one or more apertures (not shown), which may receive a coolant or lubricant from a coolant jet (not shown) configured to circulate oil from an engine crankcase. The cooling gallery 320 may permit coolant or lubricant to exit back to the crankcase via one or more apertures (not shown). While the flange 318 is illustrated as being in contact with a lower edge of the ring belt portion 310 to generally close off the cooling gallery 320, in some exemplary illustrations, a gap between the radially outer end of the flange 318 and the lower edge of the ring belt portion 310 may be provided to allow ingress/egress of a coolant to/from the cooling gallery 320. The piston skirt 304 may further include walls 322a, 322b extending axially downward from the flange 318. The walls 322a, 322b may define bores 324a, 324b, respectively, configured to receive the piston pin 308.

The connecting rod 306 may include an elongated portion 326 and a funnel portion 328 at an end of the elongated portion 326 corresponding to the piston crown 302 and piston skirt 304. The funnel portion 328 may include a boss portion 330 extending upward in an axial direction and received in the cavity 334. The funnel portion 328 may further include shoulder portions 336a, 336b on opposing sides of the boss portion 330, where surfaces of the shoulder portions 336a, 336b are in contact with bottom surfaces of the boss portions 324a, 324b of the piston crown 102, respectively. The boss portion 330 may define a bore 332 configured to receive the piston pin 308 such that the connecting rod 306 may be rotatably secured to the piston crown 302 and the piston skirt 304. The bore 332 generally is aligned with the bores 316a, 316b, 332a, and 332b.

As with the power cell units 100 and 200, when the piston assembly 301 of the power cell unit 300 moves in a reciprocating manner, for example, from a top dead center to a bottom dead center, a large downward force or gas load (represented by arrows 340), is generated. However, rather than the gas load 340 being transferred to the connecting rod 306 through the piston pin 308, as is the case in traditional power cell units, the gas load 340 may be substantially transferred directly to the connecting rod 306 through the contact between the bottom surfaces of the boss portions 314a, 314b of the piston crown 302 and the shoulder portions 336a, 336b of the connecting rod 306. Thus, the primary function of the piston pin 308 is to secure the piston assembly 301 and the connecting rod 306, and therefore, the piston pin 308 only has to withstand much smaller inertial loading (represented by the smaller arrows 342) from the piston crown 302 and the piston skirt 304. As such, the piston pin 308 may be substantially reduced in size from that of a traditional power cell unit, and/or may be made of a lighter material sufficient to withstand the inertial loading 342, thereby reducing weight of the piston pin 308 and overall weight of the power cell unit 300.

The piston assembly 301 may have a diameter, dₚᵢₛₜₒₙ, and the power cell unit 300 may also have a compression height, h_{c}, from the top of the piston assembly 301 to an axis of the piston pin 308. Due to its configuration, the power cell unit 300 may have a compression height ratio (i.e., compression height to piston diameter) smaller than traditional power cell units. For example, the compression height ratio may range from 20% to 37%, depending upon the specific application of the power cell unit. For a diesel engine, the compression height ratio may be 37% or lower. For gas engines, the compression height ratio may range from 20% to 35%, 20% to 28%, or 25% to 35% in different applications. For example, for a two-liter gasoline engine, the compression height ratio may be approximately 28.5%.

The piston pin 308 may also have a diameter, dₚᵢₙ. Due to the configuration of the power cell unit 300, a ratio of the pin diameter to the piston diameter may similarly be smaller than traditional power cell units. For example, the ratio may be less than 20%.

It should be appreciated that there may be other exemplary approaches for a power cell unit in which the gas load is transferred directly to the connecting rod as opposed to the piston pin that are not illustrated in the figures. For example, the power cell unit 300 may implement two piston pins, similar to the power cell unit 200, where the boss portion 330 of the connecting rod 306 may include notches on opposing sides of the boss portion 330 as opposed to a single bore, each notch being configured to receive one of the piston pins.

In any of the power cell units 100, 200, 300 described above, the piston crown 102, 202, 302 and the piston skirt 104, 204, 304 may or may not have the same material. For example, the material of the piston crown 102, 202, 302 may include, but is not limited to, steel, aluminum, titanium magnesium, carbon, ceramic, or any combinations thereof. The material of the piston skirt 104, 204, 304 may include, but it not limited to, aluminum, titanium, magnesium, carbon fiber, plastic, polymer, steel, or any combination thereof, for example, a metal or steel frame with a casted metal or polymer. The ability for the piston crown 102, 202, 302 and the piston skirt 104, 204, 304 to have different materials may be enabled by reduced loading on the piston pin 108, 208a, 208b, 308, as explained in more detail below. The different materials may allow for a modular design of the power cell unit 100, 200, 300 where different combinations of materials can be used to satisfy different engine and design constraints, as well as to allow for weight, load, and cost optimization.

The material of the connecting rod 106, 206, 306 also may or may not be the same as the piston crown 102, 202, 302 and/or the piston skirt 104, 204, 304 thereby furthering the modular feature of the power cell unit 100, 200, 300. For example, the material of the connecting rod 106, 206, 306 may include, but is not limited to, titanium, aluminum, steel, and a carbon fiber composite.

Referring now to FIG. 4, an exemplary piston pin 400 is shown. The piston pin 400 may be incorporated in any of the power cell units 100, 200, and 300 as piston pins 108, 208a, 208b, and 308. The piston pin 400 generally may have an elongated body with a substantially circular cross-section. Inner edges at one or both ends of the piston pin 400 may be chamfered. It should be appreciated that while FIG. 4 illustrates the piston pin 400 as having a hollow core, the piston pin 400 does not have to be hollow. As explained above, the piston pin 400 primarily serves to secure the piston assembly 101, 201, 301 to the connecting rod 106, 206, 306, and therefore, the elongated body may be able to withstand no more than approximately the inertial loading. The total loading that the elongated body may be configured to withstand may take into account tolerances for slight variations in the inertial loading that may occur, for example, due to different operating conditions. Therefore, the elongated body does not need to be sized or made of a material to withstand gas loads 140, 240, 340 generated from the reciprocal motion of the piston assembly 101, 201, 301. Thus, the size (e.g., length and/or diameter) of the piston pin 400 may be smaller and the material may be lighter than that of a traditional power cell unit of comparable size to the power cell units 100, 200, 300, thereby resulting in potential weight reduction of over 50% of the piston pin. For example, for a piston assembly having a diameter of at least 80 mm, the piston pin 400 may be made of aluminum and/or may have a diameter of 15 mm or smaller. In a traditional power cell unit having a piston assembly of this size, an aluminum piston pin with such a diameter would not be able to withstand the gas load. Other materials of the piston pin 400 may include, but are not limited to, steel, aluminum, ceramic, and/or hybrids or combinations thereof, for example where a core of the piston pin is aluminum and the shell is steel.

Referring now to FIG. 5, power cell units 100, 200, 200 generally move downward and upward within a cylinder 500. During reciprocal movement within the cylinder 500, the power cell unit may experience side loads 502 from the walls of the cylinder 500, generally referred to as “major thrust side” during downward movement and “minor thrust side” during upward movement. The side loads 502 may transfer through the piston skirt to the piston pin 400, as illustrated in FIG. 5.

Referring now to FIG. 6, an exemplary process 600 for operating power cell unit 100 is illustrated. While process 600 is described with respect to power cell unit 100, it should be appreciated that process 600 may be applicable to any of power cell units 100, 200, and 300, as well as other exemplary approaches not described above. Process 600 may begin at block 602 in which the piston assembly 101 is moved in a reciprocating manner. At block 604, a gas load 140 generated from the reciprocating motion of the piston assembly 101 may be substantially transferred directly from the boss portion 134 of the piston crown 102 to the connecting rod 106. At block 606, inertial loading from the piston crown 102 and/or piston skirt 104 may be transferred to the piston pin 108. Blocks 604 and 606 may occur substantially at the same time, and may repeat for as long as reciprocating motion of the piston assembly 101 is occurring. Process 600 may end after blocks 604 and 606.

Referring now to FIG. 7, an exemplary process 700 for using the piston pin 400. Process 700 may begin at block 702 in which at least one piston pin 400 is inserted into bores and/or notches of a piston crown, piston skirt, and connecting rod to rotatably secure the piston assembly and the connecting rod together. At block 704, the piston pin 400 may absorb only inertial loading from the piston crown and/or piston skirt during reciprocal motion of the piston assembly. Block 704 may be repeated for as long as reciprocal motion of the piston assembly is occurring. Process 700 may end after block 704.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A power cell unit, comprising:
a piston assembly having a piston crown and a piston skirt, the piston crown including a ring belt portion extending circumferentially about a combustion bowl and at least one boss portion extending downward from the combustion bowl;
a connecting rod having an elongated portion and a funnel portion at one end of the elongated portion; and
at least one piston pin configured to connect the connecting rod with the piston assembly;
wherein a bottom surface of the at least one boss portion of the piston crown engages with a corresponding surface of the funnel portion of the connecting rod such that a gas load is substantially transferred directly from the piston crown to the connecting rod during downward movement of the piston assembly.

2. The power cell unit of claim 1, wherein 100% of the gas load is transferred directly from the piston crown to the connecting rod during downward movement of the piston assembly.

3. The power cell unit of claim 1, wherein the piston skirt cooperates with the piston crown to define a cooling gallery between the ring belt portion and the combustion bowl.

4. The power cell unit of claim 1, wherein the piston skirt and the piston crown are made of a different material.

5. The power cell unit of claim 1, wherein one of the piston crown and the connecting rod define a cavity to receive a portion of the other of the piston crown and the connecting rod, and wherein at least one of:
the funnel of the connecting rod includes two tines defining the cavity, the at least one boss portion of the piston crown being received in the cavity; and
the funnel of the connecting rod includes an upwardly extending boss portion and shoulder portions on opposing sides of the upwardly extending boss portion, and the at least one boss portion of the piston crown includes two boss portions each having a bottom surface that engages a respective one of the shoulder portions.

6. The power cell unit of claim 1, wherein the funnel portion of the connecting rod includes two tines defining a cavity therebetween, the cavity receiving the at least one boss portion of the piston crown.

7. The power cell unit of claim 6, wherein the at least one piston pin includes two piston pins and the at least one boss portion of the piston crown defines two notches on opposing sides of the at least one boss portion, each of the two piston pins being press fit into a corresponding one of the two notches, the two piston pins having a common axis of rotation.

8. The power cell unit of claim 1, wherein a compression height ratio of a compression height of the power cell unit to a diameter of the piston ranges from 20% to 37%.

9. The power cell unit of claim 8, wherein the compression height ratio ranges from 20% to 30%.

10. The power cell unit of claim 8, wherein the compression height ratio ranges from 25% to 35%.

11. The power cell unit of claim 1, wherein a ratio of a diameter of the piston pin to a diameter of the piston assembly is less than 20%,

12. The power cell unit of claim 1, wherein the at least one boss portion of the piston crown includes two boss portions equally spaced radially from an axis of the piston assembly to define a cavity therebetween, and the funnel of the connecting rod includes an upwardly extending boss portion and shoulder portions on opposing sides of the upwardly extending boss portion, the cavity receiving the upwardly extending boss portion such that bottom surfaces of the two boss portions are in contact with respective ones of the shoulder portions.

13. A method, comprising:
moving a piston assembly of a power cell unit in a reciprocating manner, the piston assembly having a piston crown and a piston skirt, the piston crown including a ring belt portion extending circumferentially about a combustion bowl and at least one boss portion extending downward from the combustion bowl;
transferring a gas load generated by the reciprocating movement of the piston assembly directly from the piston crown to a connecting rod of the power cell unit through a contact between a bottom surface of the at least one boss portion and a surface of a funnel of the connecting rod; and
transferring an inertial load from at least one of the piston crown and the piston skirt to at least one piston pin that rotatably secures the piston assembly to the connecting rod.

14. The method of claim 13, wherein the funnel portion of the connecting rod includes two tines defining a cavity therebetween, the cavity receiving the at least one boss portion of the piston crown.

15. The method of claim 14, wherein the at least one piston pin includes two piston pins and the at least one boss portion of the piston crown defines two notches on opposing sides of the at least one boss portion, each of the two piston pins being press fit into a corresponding one of the two notches, the two piston pins having a common axis of rotation.

16. The method of claim 13, wherein the at least one boss portion of the piston crown includes two boss portions equally spaced radially from an axis of the piston assembly to define a cavity therebetween, and the funnel of the connecting rod includes an upwardly extending boss portion and shoulder portions on opposing sides of the upwardly extending boss portion, the cavity receiving the upwardly extending boss portion such that bottom surfaces of the two boss portions are in contact with respective ones of the shoulder portions.

17. A power cell unit, comprising:
a piston assembly;
a connecting rod; and
at least one piston pin configured to connect the connecting rod with the piston assembly;
wherein the piston assembly engages with the connecting rod during reciprocal movement of the piston assembly such that a gas load generated from downward movement of the piston assembly substantially transfers directly from the piston assembly to the connecting rod, and approximately no more than an inertial load generated from upward movement of the piston assembly is transferred to the at least one piston pin; and
wherein a compression height ratio of a compression height of the power cell unit to a diameter of the piston assembly ranges from 20% to 37%.

18. The power cell unit of claim 17, wherein the connecting rod includes a funnel portion having two tines defining a cavity therebetween, and the piston assembly includes a piston crown having a boss portion extending downwardly from a combustion bowl of the piston crown, the cavity receiving the boss portion.

19. The power cell unit of claim 18, wherein the at least one piston pin includes two piston pins and the boss portion of the piston crown defines two notches on opposing sides of the boss portion, each of the two piston pins being press fit into a corresponding one of the two notches, the two piston pins having a common axis of rotation.

20. The power cell unit of claim 17, wherein the piston skirt and the piston crown are made of a different material.
